(19) United States
(12) Patent Application Publication
(10) Pub. No.: US 2013/0043271 A1
(43) Pub. Date: Feb. 21, 2013

(54) Interactive Video Vending Machine

(71) Applicants: Audra South, Blue Springs, MO (US); Nicole Crowe, Blue Springs, MO (US); Bonita Crowe, Blue Springs, MO (US)

(72) Inventors: Audra South, Blue Springs, MO (US); Nicole Crowe, Blue Springs, MO (US); Bonita Crowe, Blue Springs, MO (US)

(21) Appl. No.: 13/584,779

(22) Filed: Aug. 13, 2012

Related U.S. Application Data
(60) Provisional application No. 61/525,283, filed on Aug. 19, 2011.

(51) Int. Cl. G07F 11/72; G06F 3/048; G07F 7/08

(52) U.S. Cl. 221/199

(57) ABSTRACT

An interactive vending machine comprising a touch screen interactive display, where the display provides a visual and audio information concerning goods within the vending machine upon activation by the consumer; a purchasing means, where the purchasing means includes a credit card acceptor, a bill receiver and a coin receiver; a dispensing door, where the dispensing door enables access to the goods after purchase; and a payment receipt dispenser. The touch screen includes a video display to display advertisements pertaining to the goods within the vending machine.

### CROSS REFERENCE TO OTHER APPLICATIONS

This application claims priority to U.S. Provisional Application Ser. No. 61/525283 filed on Aug. 19, 2011.

### BACKGROUND OF THE INVENTION

1. Field of Invention

The present invention relates to a vending machine for dispensing goods that includes an interactive visual display.

2. Description of Related Art

Vending machines are used throughout society to purchase and dispense various goods to consumers. Consumers may purchase beverages, snacks, personal hygiene items or tobacco products all through a stand-alone vending machine. The typical vending machine receives payment for the goods via a receptacle that may receive money in the form of dollar bills or coins. Further other vending machines may also accept credit card payment for the particular goods that are dispensed through the vending machine. Most vending machines provide an open and clear view of the goods within the vending machine for purchase. Other vending machines may provide a simple visual description or a brand label on a series of tabs that may be actuated to purchase the goods. Some vending machines may include a large marketing display along the front side or side panels of the vending machine that may be associated with a particular good being dispensed in the vending machine. The prior art fails to provide a vending machine that may include an interactive visual display that functions as both an informational display for goods provided within the vending machine and an advertising means for visually displaying advertisement when the machine is not being used for dispensing purposes.

### SUMMARY OF THE INVENTION

In view of the foregoing disadvantages inherent in the prior art, the general purpose of the present invention is to provide a vending machine with video display, configured to include all of the advantages of the prior art, and to overcome the drawbacks inherent therein.

Accordingly, an object of the present invention is to provide a vending machine with an interactive touch screen to display information and advertisements regarding the goods sold within the vending machine.

To achieve the above objects, in an aspect of the present invention, an interactive vending machine is described comprising a touch screen interactive display, where the display provides a visual and audio information concerning goods within the vending machine upon activation by the consumer; a purchasing means, where the purchasing means includes a credit card acceptor, a bill receiver and a coin receiver; a dispensing door, where the dispensing door enables access to the goods after purchase; and a payment receipt dispenser. The touch screen includes a video display to display advertisements pertaining to the goods within the vending machine.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF DRAWINGS

FIG. 1 depicts a front view of an exemplary embodiment of a vending machine according to the present invention.

### DETAILED DESCRIPTION

The present invention relates to an interactive video display vending machine that provides the user with visual information regarding the goods available through the machine. The vending machine according to present invention further provides advertisement for not only goods within the vending machine but for any particular advertiser who wished to display either a slogan or even perhaps a visual commercial via the video display provided on the vending machine.

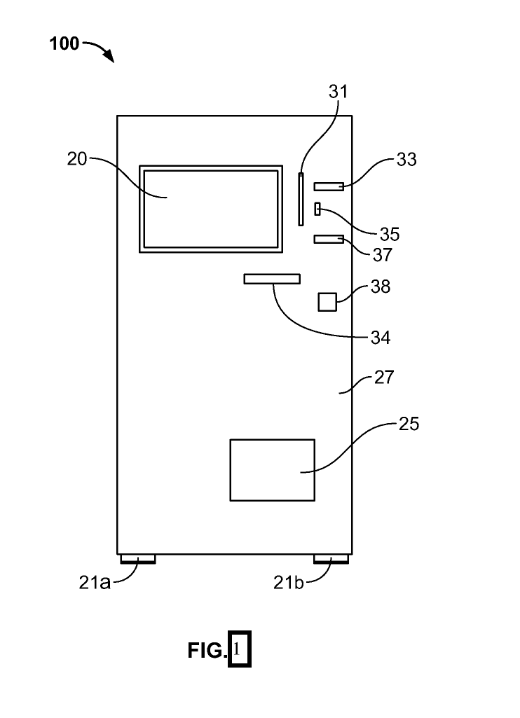

FIG. 1 depicts a Vending Machine 100 according to the present invention. The Vending Machine 100 includes an interactive visual Video Display 20 that is utilized to share information with consumers who may be purchasing goods from the vending machine. The interactive Video Display 20 also provides a visual means to display advertisement when not specifically in use for purchase of goods within the vending machine.

A front Side 27 is shown in FIG. 1 of the Vending Machine 100. Along the front side includes a means for purchasing goods within the vending machine. The means for purchase includes a Credit Card Acceptor 31, a Bill Receiver 33 and a Coin Receiver 35. This provides the consumer the three forms of payment for goods within the Vending Machine 100. In one particular embodiment, the user may execute multiple purchases with a single credit card transaction. Further, although described as a credit card transaction, a debit card, gift card or any other magnetic strip transaction card is applicable. If a user is using a debit card, then the Machine 100 allows for the user to receive currency back as part of the transaction. A bill Dispenser 34 is provided for the purpose of currency distribution. A coin return 38 is provided to dispense any coins back to the purchaser. In addition to the purchasing options available a consumer receives a receipt via the Receipt Dispenser 37 if so desired. The goods stored within the vending machine may be dispensed through a goods dispensing Door 25 depicted on the front Side 27 of the vending machine. Although not specifically noted with the Vending Machine 100, this configuration and means of interactive purchasing may be utilized on a refrigerated vending machine or alternatively in a non-refrigerated vending machine. Additionally the Vending Machine 100 is supported upon support Feet 21a, 21b shown along the bottom edge of the Vending Machine 100.

The Vending Machine 100 uniquely includes the interactive visual Video Display 20 as a central means to gather information regarding the contents of the vending machine and the particular information about each good sold in the vending machine. A user may use an actual touch along the screen of the video Display 20 to select a particular good available for purchase from the Vending Machine 100. This touch interaction allows the user to make a selection of a particular good and then provide additional information about the particular goods' nutritional value if the goods are edible substances or further information about the product being purchased through the Vending Machine 100. In some instances some items available for purchase may also include a visual display of instructions on how to use the particular device purchased through the vending machine. The consumer simply indicates through the use of the interactive touch screen provided on the Video Display 20 the desired information concerning the goods within the Vending Machine 100. Further the consumer receives information on pricing of the goods within the vending machine and may be queued through a sequence of steps to complete the purchase of the goods within the Vending Machine 100. Finally, the touch screen Video Display 20 may enable the user to select the amount to dispense into the bill Dispenser 34 if a debit card transaction is selected. The Video Display 20 provides the owner of the vending machine opportunity to display advertisement on the Video Display 20 when the machine is not specifically being used for purchasing goods. This feature allows merchants or marketers to display advertisement that may be associated with goods that are being sold through the vending machine. The visual display may also include audio along with the visual display of the goods available. In addition to providing a display for goods that were sold through a vending machine the display may simply be used for commercial advertisement of any good or service based upon a time sequence of commercials or advertisements that may be displayed throughout a period of time and available for purchase. As the consumer approaches the vending machine to purchase goods, a portion of the video display is always available for the consumer to touch to activate the purchasing sequence.

The vending machine according to the present invention consequently provides the consumer with an interactive touch screen to accomplish the purchasing of goods within the vending machine. The video display also provides the owner of the vending machine the opportunity to sell and display advertisement that may be specifically related to goods within the vending machine. This vending machine according to present invention therefore uniquely provides greater marketing opportunities for merchants and greater information on interactive communication for the consumer. The instant invention has been shown and described in what it considers to be the most practical and preferred embodiments. It is recognized, however, that departures may be made there from within the scope of the invention and that obvious modifications will occur to a person skilled in the art.

What is claimed is:

1. An interactive vending machine comprising:
a. a touch screen interactive display, where the display provides a visual and audio information concerning goods within the vending machine upon activation by the consumer;
b. a purchasing means, where the purchasing means includes a credit card acceptor, a bill receiver and a coin receiver;
c. a dispensing door, where the dispensing door enables access to the goods after purchase; and
d. a payment receipt dispenser.

2. The interactive vending machine according to claim 1, where the credit card acceptor receives credit cards, debit cards and gift cards.

3. The interactive vending machine according to claim 2, where utilization of the debit card allows for a currency receipt transaction.

4. The interactive vending machine according to claim 1, where the vending machine includes a set of support feet.

5. The interactive vending machine according to claim 1, where the touch screen includes a video display to display a plurality of advertisements pertaining to the goods within the vending machine.
